(19) United States
(12) Patent Application Publication
(10) Pub. No.: US 2013/0171968 A1
(43) Pub. Date: Jul. 4, 2013

(54) APPARATUS FOR DELETING PERSONAL DATA STORED IN PORTABLE ELECTRONIC DEVICE

(71) Applicant: Peng WANG, Shenzhen City (CN)

(72) Inventor: Peng WANG, Shenzhen City (CN)

(73) Assignees: HON HAI PRECISION INDUSTRY CO., LTD., Tu-Cheng (TW); Fu Tai Hua Industry (Shenzhen) Co., Ltd., ShenZhen City (CN)

(21) Appl. No.: 13/420,584

(22) Filed: Mar. 14, 2012

(30) Foreign Application Priority Data
Dec. 28, 2011 (CN) 201110446540.9

(51) Int. Cl. H04W 12/06; H04W 12/08

(52) U.S. Cl. 455/411; 455/410

(57) ABSTRACT

An apparatus for deleting personal data stored in a portable electronic device includes a global position system (GPS) unit, a storage unit, a signal receiving unit, and a control unit. The GPS unit determines a real time location of the portable electronic device. The storage unit stores personal data and the real time location determined by the GPS unit. The signal receiving unit receives a signal sent from a remote control terminal. The remote control terminal sends the signal if a distance between the remote control terminal and the portable electronic device is within a predetermined range. The control unit erases the personal data stored in the storage unit of the portable electronic device in response to the signal received by the signal receiving unit.

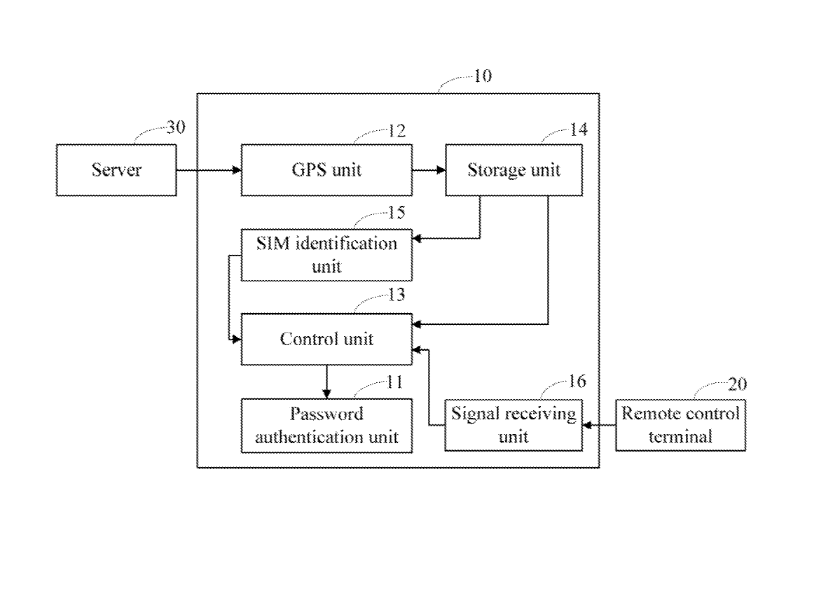

### BACKGROUND

1. Technical Field

The present disclosure relates to an apparatus that is used for deleting personal data stored in a portable electronic device.

2. Description of the Related Art

If a mobile phone is lost or stolen, private data stored in the mobile phone may be at risk. In some cases, a mobile phone owner can send a message to his lost or stolen phone to delete the private data. However, if the SIM card is removed by someone before the message sent then of course the data will not be deleted.

### BRIEF DESCRIPTION OF THE DRAWINGS

The components in the drawings are not necessarily drawn to scale, the emphasis instead being placed upon clearly illustrating the principles of the disclosure. Moreover, in the drawings, like reference numerals designate corresponding parts throughout the several views.

The figure is a block diagram of an apparatus for deleting personal data stored in a portable electronic device in accordance with an exemplary embodiment.

### DETAILED DESCRIPTION

The figure is a block diagram of an apparatus 10 for deleting personal data stored in a portable electronic device. The apparatus 10 can be employed in a mobile phone, a tablet computer, and so on. In the embodiment, the apparatus 10 is employed in a mobile phone.

The apparatus 10 include a password authentication unit 11, a global position system (GPS) unit 12, a control unit 13, a storage unit 14, and a SIM identification unit 15. The GPS unit 12 is configured to determine a real time location of the mobile phone. The storage unit 14 is configured to store personal data, such as address list, and the real time location determined by the GPS unit 12. The SIM obtaining unit 15 is configured to obtain a SIM identification code of a SIM card in the mobile phone when the mobile phone is powered on. The control unit 13 determines whether the obtained SIM identification code is the same as a SIM identification code which is pre-stored in the storage unit 14. If the obtained SIM identification code is different from the pre-stored SIM identification code, the control unit 13 enables the password authentication unit 11. The password authentication unit 11 is configured to provide a password authentication interface for a user to input a password, and determine whether the input password matches a preset password. If the input password does not match with the preset password, the password authentication unit 11 locks the mobile phone to disable the mobile phone.

The apparatus 10 further includes a signal receiving unit 16. The signal receiving unit 16 is configured to receive a signal sent from a remote control terminal 20. If the signal is received by the signal receiving unit 16, the control unit 13 erase the personal data stored in the data storage of the electronic device. In the embodiment, the remote control terminal 20 can be an infrared device, a radio frequency (RF) device, or a BLUETOOTH device.

In the embodiment, when the mobile phone is lost or stolen, the owner of the phone obtains the location of the phone via a server 30 communicating with the apparatus 10 to get the location determined by the GPS unit 12. Therefore, the owner can attempt to get to the phone's location. When a distance between the owner and the lost or stolen phone is within a predetermined range, the owner can activate the remote control terminal 20 to send a signal to the mobile phone to delete the data stored in the data storage of the mobile phone. In the embodiment, the server 30 is a personal computer.

It is understood that the present disclosure may be embodied in other forms without departing from the spirit thereof. Thus, the present examples and embodiments are to be considered in all respects as illustrative and not restrictive, and the disclosure is not to be limited to the details given herein.

What is claimed is:

1. An apparatus for deleting personal data stored in a portable electronic device comprising:
a global position system (GPS) unit configured to determine a real time location of the portable electronic device;
a storage unit configured to store personal data and the real time location determined by the GPS unit;
a signal receiving unit configured to receive a signal sent from a remote control terminal, the remote control terminal configured to send the signal if a distance between the remote control terminal and the portable electronic device is within a predetermined range; and
a control unit configured to erase the personal data stored in the storage unit of the portable electronic device in response to the signal received by the signal receiving unit.

2. The apparatus for deleting personal data stored in a portable electronic device as recited in claim 1, further comprising:
a SIM obtaining unit configured to obtain a SIM identification code of a SIM card in the portable electronic device when the portable electronic device is powered on, the control unit is further configured to determine whether the obtained SIM identification code is the same as a SIM identification code which is pre-stored in the storage unit; and
a password authentication unit, the control unit configured to activate the password authentication unit if the obtained SIM identification code is different from the pre-stored SIM identification code, the password authentication unit configured to provide a password authentication interface for a user to input a password, and determine whether the input password matches with a preset password.

3. The apparatus for deleting personal data stored in a portable electronic device as recited in claim 2, wherein the password authentication unit is further configured to disable the portable electronic device if the input password does not match with the preset password.
